(19) United States
(12) Patent Application Publication
(10) Pub. No.: US 2025/0227523 A1
(43) Pub. Date: Jul. 10, 2025

(54) METHOD FOR MEASUREMENT INDICATION AND COMMUNICATION APPARATUS

(71) Applicant: Beijing Xiaomi Mobile Software Co., Ltd., Beijing (CN)

(72) Inventor: Xuhua TAO, Beijing (CN)

(73) Assignee: Beijing Xiaomi Mobile Software Co., Ltd., Beijing (CN)

(21) Appl. No.: 18/847,137

(22) PCT Filed: Mar. 16, 2022
(86) PCT No.: PCT/CN2022/081267

§ 371 Date: Sep. 13, 2024

(51) Int. Cl. H04W 24/08

(52) U.S. Cl. CPC H04W 24/08

(57) ABSTRACT

The present disclosure provides a method and an apparatus for measurement indication, a storage medium, and a communication apparatus. The method for measurement indication is performed by a user device UE and includes: acquiring RRM requirement enhancement indication information sent by a network side device, where the RRM requirement enhancement indication information is configured to indicate an enhanced RRM requirement required to be met in a process that the UE performs RRM measurement.

### CROSS-REFERENCE

The present application is a U.S. National Stage of International Application No. PCT/CN2022/081267, filed on Mar. 16, 2022, the entire content of which is incorporated herein by reference for all purposes.

### TECHNICAL FIELD

The present disclosure relates to a field of communication technology, and more particularly, to a method and a device for measurement indication, a non-transitory storage medium, and an apparatus.

### BACKGROUND

In NR (New Radio) FR (Frequency range) 2, a FR2 RRM (Radio Resource Management) requirement is introduced to perform RRM measurement for cell reselection/switching to achieve the mobility management of a UE (UserEquipment).

### SUMMARY

The present disclosure proposes a method and a device for measurement indication, a non-transitory storage medium, and an apparatus, to solve the technical problem that the FR 2 RRM requirement affects the mobility management performance of the UE in the related art.

A method for measurement indication proposed according to embodiments of an aspect of the present disclosure, performed by a user device UE, and the method includes:
acquiring RRM requirement enhancement indication information sent by a network side device, where the RRM requirement enhancement indication information is configured to indicate an enhanced RRM requirement required to be met in a process that the UE performs RRM measurement.

A method for measurement indication proposed according to embodiments of another aspect of the present disclosure, performed by a network side device, and the method includes:
sending RRM requirement enhancement indication information to a UE, where the RRM requirement enhancement indication information is configured to indicate an enhanced RRM requirement required to be met in a process that the UE performs RRM measurement.

An apparatus for measurement indication proposed according to embodiments of another aspect of the present disclosure includes:
an acquisition module, configured to acquire RRM requirement enhancement indication information sent by a network side device, where the RRM requirement enhancement indication information is configured to indicate an enhanced RRM requirement required to be met in a process that a UE performs RRM measurement.

An apparatus for measurement indication proposed according to embodiments of another aspect of the present disclosure includes
a sending module, configured to send RRM requirement enhancement indication information to a UE, where the RRM requirement enhancement indication information is configured to indicate an enhanced RRM requirement required to be met in a process that the UE performs RRM measurement.

A communication apparatus proposed according to embodiments of another aspect of the present disclosure includes a processor and a memory, the memory is configured to store a computer program; and the processor is configured to execute the computer program stored in the memory to implement the method according to embodiments of the above aspect.

A communication apparatus proposed according to embodiments of another aspect of the present disclosure includes a processor and a memory, the memory is configured to store a computer program; and the processor is configured to execute the computer program stored in the memory to implement the method according to embodiments of the above another aspect.

A communications apparatus according to embodiments of another aspect includes a processor and an interface circuit,
the interface circuit is configured to receive code instructions and transmit the code instructions to the processor; and
the processor is configured to run the code instructions to perform the method according to embodiments of the above aspect.

A communications apparatus according to embodiments of another aspect includes a processor and an interface circuit,
the interface circuit is configured to receive code instructions and transmit the code instructions to the processor; and
the processor is configured to run the code instructions to perform the method according to embodiments of the above another aspect.

A non-transitory computer-readable storage medium proposed according to embodiments of another aspect of the present disclosure, which is stored with instructions, where when the instructions are executed, the method according to embodiments of the above aspect is implemented.

A non-transitory computer-readable storage medium according to embodiments of another aspect of the present disclosure, which is stored with instructions,
where when the instructions are executed, the method according to embodiments of the above another aspect is implemented.

Additional aspects and advantages of the present disclosure will be given in part in the following description, become apparent in part from the following description, or be learned by practice of the present disclosure.

### BRIEF DESCRIPTION OF THE DRAWINGS

The above and/or additional aspects and advantages of the embodiments of the present disclosure will become apparent and more readily from the following descriptions made with reference to the accompanying drawings, in which:

FIG. 1a is a flowchart of a method for measurement indication provided in embodiments of the present disclosure;

FIG. 1b is a flowchart of a method for measurement indication provided by another embodiment of the present disclosure;

FIG. 1c is a flowchart of a method for measurement indication provided by another embodiment of the present disclosure;

FIG. 2 is a flowchart of a method for measurement indication provided by another embodiment of the present disclosure;

FIG. 3 is a flowchart of a method for measurement indication provided in yet another embodiment of the present disclosure;

FIG. 4a is a flowchart of a method for measurement indication provided by another embodiment of the present disclosure;

FIG. 4b is a flowchart of a method for measurement indication provided by another embodiment of the present disclosure;

FIG. 4c is a flowchart of a method for measurement indication provided by another embodiment of the present disclosure;

FIG. 5 is a flowchart of a method for measurement indication provided by another embodiment of the present disclosure;

FIG. 6 is a structural diagram of an apparatus for measurement indication provided in an embodiment of the present disclosure;

FIG. 7 is a structural diagram of an apparatus for measurement indication provided in another embodiment of the present disclosure;

FIG. 8 is a block diagram of a user device provided in an embodiment of the present disclosure;

FIG. 9 is a block diagram of a base station provided in an embodiment of the present disclosure.

### DETAILED DESCRIPTION

Reference will now be made in detail to illustrate the embodiments, examples of which are illustrated in the accompanying drawings. The following description refers to the accompanying drawings in which the same numbers in different drawings represent the same or similar elements unless otherwise represented. The implementations set forth in the following description of illustrative embodiments do not represent all implementations consistent with the disclosure. Instead, they are merely examples of apparatuses and methods consistent with aspects related to the embodiments of the present disclosure as recited in the appended claims.

Terms used herein in the description of the present disclosure are only for the purpose of describing specific embodiments, but should not be construed to limit the present disclosure. As used in the description of the present disclosure and the appended claims, “a” and “the” in singular forms mean including plural forms, unless clearly indicated in the context otherwise. It should also be understood that, as used herein, the term “and/or” represents and contains any one and all possible combinations of one or more associated listed items.

It should be understood that, although terms such as “first,” “second” and “third” are used herein for describing various information, these information should not be limited by these terms. These terms are only used for distinguishing information of the same type. For example, first information may also be referred to as second information, and similarly, the second information may also be referred to as the first information, without departing from the scope of the present disclosure. As used herein, the term “if” may be construed to mean “when” or “upon” or “in response to determining” depending on the context.

Embodiments of the present disclosure are described in detail below, examples of which are illustrated in the drawings, where the same or similar reference numerals throughout indicate the same or similar elements. The embodiments described below with reference to the accompanying drawings are exemplary and intended to explain the present disclosure. The embodiments cannot be construed to limit the present disclosure.

In the related art, latency is too long when the UE performs the RRM measurement based on a current RRM requirement. For example, when the UE in an RRC (Radio Resource Control) idle state performs cell reselection based on the RRM requirement, when a DRX (Discontinuous Reception) period is 1.28 s, the UE needs 32×4=128 s to complete the cell reselection, which may affect the mobility management performance of the UE.

A method and a device for measurement indication, a non-transitory storage medium, and an apparatus provided in the present disclosure are described in detail below with reference to the accompanying drawings.

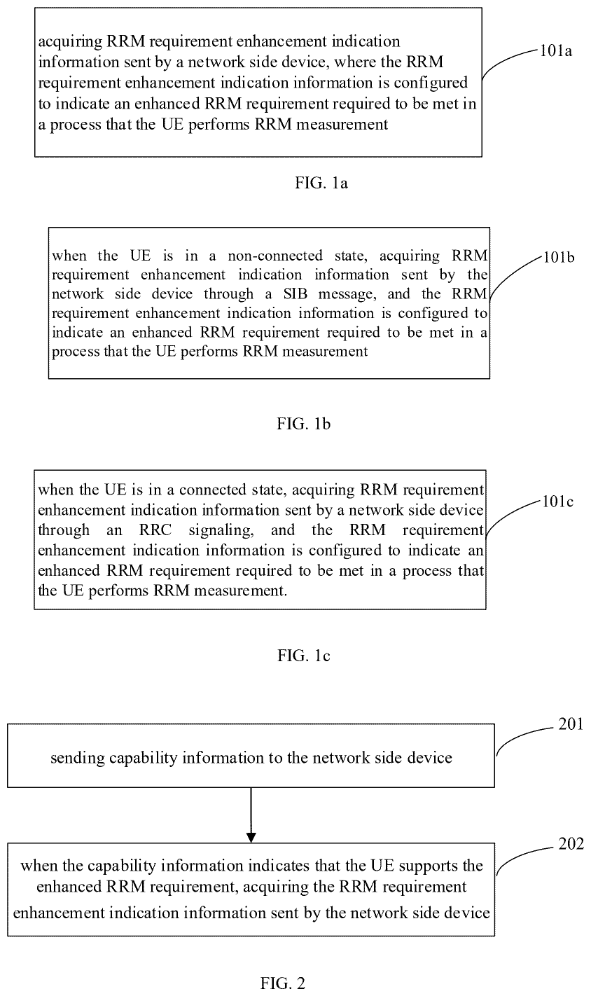

FIG. 1a is a flowchart of a method for measurement indication provided in embodiments of the present disclosure, which is performed by a UE. As shown in FIG. 1a, the method for measurement indication may include a following step 101a:
in step 101a: Radio Resource Management (RRM) requirement enhancement indication information sent by a network side device is acquired, where the RRM requirement enhancement indication information is configured to indicate an enhanced RRM requirement required to be met in a process that the UE performs RRM measurement.

It should be noted that in the embodiment of the present disclosure, a UE may be a device that provides voice and/or data connectivity to a user. The UE may communicate with one or more core networks via a radio access network (RAN). The UE may be an internet of things (IoT) terminal such as a sensor device, a mobile phone (or a cellular phone), and a computer with the IoT terminal such as a fixed, portable, pocket-sized, handheld, built-in computer, or vehicle-mounted device, for example, station (STA), subscriber unit, subscriber station, mobile station, mobile, remote station, access point, remote terminal, access terminal, user terminal, or user agent. Alternatively, the UE may also be a device of an unmanned aircraft. Alternatively, the UE may also be an in-vehicle device, for example, a trip computer with a wireless communication function or a wireless terminal connected to the trip computer. Alternatively, the UE may also be a roadside device, for example, a street lamp, a signal lamp, or other roadside device, having the wireless communication function.

In an embodiment of the present disclosure, the above enhanced RRM requirement is stricter than an unenhanced RRM requirement, where the “stricter than” is mainly reflected in that: a duration required to complete one RRM measurement process using the enhanced RRM requirement is less than a duration required to complete one RRM measurement process using the unenhanced measurement requirement.

In an embodiment of the present disclosure, the above enhanced RRM requirement may include at least one of the following:
an enhanced mobility requirement for the UE in a non-connected state;
an enhanced mobility requirement for the UE in a connected state;
an enhanced cell activation latency requirement;
an enhanced cell deactivation latency requirement; or
an enhanced beam management requirement.

In an embodiment of the present disclosure, a mobility requirement for the UE in the non-connected state (such as an idle state and/or an inactive state) are mainly used for that: the UE in the non-connected state performs the RRM measurement on a neighbor cell based on the mobility requirement for the UE in the non-connected state, such that the UE autonomously performs the cell selection or the cell reselection based on a measurement result.

Furthermore, in an embodiment of the present disclosure, the mobility requirement for the UE in the non-connected state may at least include: an identification requirement for cell identification and a measurement requirement for cell measurement. In an embodiment of the present disclosure, the above cell identification may include: obtaining a cell identification code of a neighbor cell by identifying the neighbor cell; the above cell identification may specifically include: after identifying the neighbor cell, performing the cell measurement on an identified cell. In an embodiment of the present disclosure, the measurement requirement for the cell measurement may include at least one of the following: performing RRM measurement on an intra-frequency cell, performing RRM measurement on an inter-frequency cell, and performing RRM measurement on an inter-system cell.

Furthermore, in an embodiment of the present disclosure, the enhanced mobility requirement for the UE in the non-connected state is stricter than an unenhanced mobility requirement for the UE in the non-connected state, where the “stricter than” is mainly reflected in that: a duration required for the UE in the non-connected state to complete one RRM measurement process based on the enhanced mobility requirement for the UE in the non-connected state is less than a duration required for the UE in the non-connected state to complete one RRM measurement process based on the unenhanced mobility requirement for the UE in the non-connected state.

For example, in an embodiment of the present disclosure, assuming that a duration for the UE in the non-connected state to complete one RRM measurement process based on the unenhanced mobility requirement for the UE in the non-connected state is 200 s, a duration for the UE in the non-connected state to complete one RRM measurement process based on the enhanced mobility requirement for the UE in the non-connected state should be less than 200 s, and may be, for example, 100 s.

In addition, in an embodiment of the present disclosure, the mobility requirement for the UE in the connected state is mainly used for that: the UE in the connected state performs the RRM measurement on a neighbor cell based on the mobility requirement for the UE in the connected state, and reports a RRM measurement result to the network side device to assist the network side device in making a judgment of switching the cell.

In an embodiment of the present disclosure, the mobility requirement for the UE in the connected state may at least include: an identification requirement for cell identification and a measurement requirement for cell measurement, which may refer to the relevant introduction of the identification requirement for cell identification and the measurement requirement for cell measurement in the mobility requirement for the UE in the non-connected state, and the embodiments of the present disclosure will not be repeated herein.

Furthermore, in an embodiment of the present disclosure, the enhanced mobility requirement for the UE in the connected state is stricter than an unenhanced mobility requirement for the UE in the connected state, where the “stricter than” is mainly reflected in that: a duration required for the UE in the connected state to complete one RRM measurement process based on the enhanced mobility requirement for the UE in the connected state is less than a duration required for the UE in the connected state to complete one RRM measurement process based on the unenhanced mobility requirement for the UE in the connected state.

For example, in an embodiment of the present disclosure, assuming that a duration for the UE in the connected state to complete one RRM measurement process based on the unenhanced mobility requirement for the UE in the connected state is 200 s, a duration for the UE in the connected state to complete one RRM measurement process based on the enhanced mobility requirement for the UE in the connected state should be less than 200 s, and may be, for example, 100 s.

In an embodiment of the present disclosure, the cell activation latency requirement is specifically used for that: the UE completes the cell activation based on the cell activation latency requirement after receiving an activation signal sent by the network device. In an embodiment of the present disclosure, the above cell activation latency requirement may be, for example, a SCell (Secondary Cell) cell activation latency requirement. In addition, in an embodiment of the present disclosure, the enhanced cell activation latency requirement is stricter than an unenhanced cell activation latency requirement, where the “stricter than” is mainly reflected in that: a duration required for the UE to complete the cell activation based on the enhanced cell activation latency requirement is less than a duration required for the UE to complete the cell activation based on the unenhanced cell activation latency requirement.

For example, in an embodiment of the present disclosure, assuming that a duration for the UE to complete the cell activation based on the unenhanced cell activation latency requirement is 50 s, a duration for the UE to complete the cell activation based on the enhanced cell activation latency requirement should be less than 50 s, and may be, for example, 25 s.

In an embodiment of the present disclosure, a cell deactivation latency requirement is specifically used for that: the UE completes the cell deactivation based on the cell deactivation latency requirement after receiving a deactivation signal sent by the network device. In an embodiment of the present disclosure, the above cell deactivation latency requirement may be, for example, a SCell cell deactivation latency requirement. Furthermore, in an embodiment of the present disclosure, the enhanced cell deactivation latency requirement is stricter than an unenhanced cell deactivation latency requirement, where the “stricter than” is mainly reflected in that: a duration required for the UE to complete the cell deactivation based on the enhanced cell deactivation latency requirement is less than a duration required for the UE to complete the cell deactivation based on the unenhanced cell deactivation latency requirement.

For example, in an embodiment of the present disclosure, assuming that a duration for the UE to complete the cell deactivation based on the unenhanced cell deactivation latency requirement is 50 s, a duration for the UE to complete the cell deactivation based on the enhanced cell deactivation latency requirement should be less than 50 s, and may be, for example, 25 s.

In an embodiment of the present disclosure, a beam management requirement is mainly used for that: the UE measures a beam based on the beam management requirement, and evaluates whether the beam is faulty or good based on a measurement results. In an embodiment of the present disclosure, the beam management may include a beam measurement requirement and a beam evaluation requirement. Specifically, in an embodiment of the present disclosure, the beam management requirement may include a FR2 L1-RSRP (Level 1—Reference Signal Receiving Power) measurement requirement and a FR2 L1-RSRP evaluation requirement, or may include a BFD (beam failure detection) measurement requirement and a BFD evaluation requirement, or may include a CBD (candidate beam detection) measurement requirement and a CBD evaluation requirement.

In an embodiment of the present disclosure, the BFD measurement requirement mainly refers to that: the UE measures a beam failure detection reference signal configured by the network side device during an evaluation period based on the evaluation period, and the BFD evaluation requirement mainly refers to that the UE evaluates whether a beam failure occurs based on a BFD measurement result.

In addition, in an embodiment of the present disclosure, the CBD measurement requirement is mainly used for that: the UE measures a candidate beam based on an evaluation period within the evaluation period. The CBD evaluation requirement is mainly used for that: the UE evaluates whether the candidate beam is good based on a CBD measurement result.

Furthermore, in an embodiment of the present disclosure, the L1-RSRP measurement requirement is mainly used for that: the UE periodically measures L1-RSRP based on a measurement period, and the L1-RSRP evaluation requirement is mainly used for that: the UE periodically evaluates L1-RSRP based on an evaluation period and reports an evaluation result to the network side device.

In addition, in an embodiment of the present disclosure, the enhanced beam management requirement is stricter than an unenhanced beam management requirement, where the “stricter than” is mainly reflected in that: a duration required to complete one beam measurement and evaluation process based on the enhanced beam management requirement is less than a duration required to complete one beam measurement and evaluation process based on the unenhanced beam management requirement.

For example, in an embodiment of the present disclosure, assuming that a duration required for the UE to complete one beam measurement and evaluation process based on the unenhanced beam management requirement is 50 s, a duration required for the UE to complete one beam measurement and evaluation process based on the enhanced beam management requirement should be less than 50 s, and may be, for example, 25 s.

In addition, in an embodiment of the present disclosure, the method for acquiring the RRM requirement enhancement indication information sent by the network side device may include: when the UE is in a non-connected state, acquiring the RRM requirement enhancement indication information sent by the network side device through a SIB (System Information Block) message.

In another embodiment of the present disclosure, the method of acquiring the RRM requirement enhancement indication information sent by the network side device may include: when the UE is in a connected state, acquiring the RRM requirement enhancement indication information sent by the network side device through an RRC signaling.

Furthermore, it should be noted that in an embodiment of the present disclosure, after acquiring the RRM requirement enhancement indication information sent by the network side device, the UE may subsequently perform the RRM measurement by using the enhanced RRM requirement according to the RRM requirement enhancement indication information.

Furthermore, it should be noted that in an embodiment of the present disclosure, both the enhanced RRM requirement and the unenhanced RRM requirement are pre-agreed based on a protocol. A format of the enhanced RRM requirement is the same as a format of the unenhanced RRM requirement, but a value corresponding to the enhanced RRM requirement is stricter than a value corresponding to the unenhanced RRM requirement. The meaning of “stricter than” is described with reference to the above-described embodiments, which will not be repeated herein.

The format of the unenhanced RRM requirement is described in detail below, and the format of the enhanced RRM requirement is minutely similar to the format of the unenhanced RRM requirement. Table 1 provides a format of an unenhanced RRM requirement provided by an embodiment of the present disclosure.

TABLE 1

| DRX | Scaling | | T_{detect, NR}_{_{—}}_{Intra} | T_{measure, NR}_{_{—}}_{Intra} | T_{evaluate, NR}_{_{—}}_{Intra} |
|---|---|---|---|---|---|
| cycle | Factor (N1) | | [s] (number of | [s] (number of | [s] (number of |
| length [s] | FR1 | FR2^{Note1} | DRX cycles) | DRX cycles) | DRX cycles) |
| 0.32 | 1 | 8 | 11.52 × N1 × M2 | 1.28 × N1 × M2 | 5.12 × N1 × M2 |
| | | | (36 × N1 × M2) | (4 × N1 × M2) | (16 × N1 × M2) |
| 0.64 | | 5 | 17.92 × N1 (28 × N1) | 1.28 × N1 (2 × N1) | 5.12 × N1 (8 × N1) |
| 1.28 | | 4 | 32 × N1 (25 × N1) | 1.28 × N1 (1 × N1) | 6.4 × N1 (5 × N1) |
| 2.56 | | 3 | 58.88 × N1 (23 × N1) | 2.56 × N1 (1 × N1) | 7.68 × N1 (3 × N1) |

^{Note1}
Applies for UE supporting power class 2&3&4. For UE supporting power class 1 or 5, N1 = 8 for all DRX cycle length.
Note 2:
M2 = 1.5 if SMTC (Single Side Band Measurement Timing Configuration) periodicity of measured intra-frequency cell > 20 ms; otherwise M2 = 1. If different SMTC periodicities are configured for different cells, the SMTC periodicity in this table is the periodicity used by the cell being identified. During PSS (Primary Synchronization Signal)/SSS (Secondary Synchronization Signal) detection, the periodicity of the SMTC configured for the intra-frequency carrier is assumed, and if the actual SSB (Single Side Ban, Synchronization Signal) transmission periodicity is greater than the SMTC configured for the intra-frequency carrier, longer T_{detect, NR}_{_{—}}ᵢₙₜᵣₐ is expected.

As shown in Table 1, for the RRM requirement, corresponding to different DRX cycle lengths, the UE terminal is correspondingly stored with specific values of different scale factors, the detection cycle Tdetect,NR_Intra, the measurement cycle Tmeasure,NR_Intra, and the evaluation cycle Tevaluate,NR_Intra. Based on this, the UE may determine values of the corresponding Tdetect,NR_Intra, Tmeasure,NR_Intra and Tevaluate,NR_Intra based on the DRX cycle length and the scaling factor, and then, the UE may perform the RRM measurement by using the Tdetect,NR_Intra, Tmeasure,NR_Intra and Tevaluate,NR_Intra.

For example, in an embodiment of the present disclosure, assuming a current DRX cycle length is 1.28 and a current FR2 system, the scaling factor may be determined to be 4. Based on this, Tdetect,NR_Intra=32×N1=32×4=128 s, Tmeasure,NR_Intra=1.28×N1=1.28×4=5.12 s, and Tevaluate,NR_Intra=6.4×N1=6.4×4=25.6 s. Then, the UE may perform the RRM measurement based on the determined Tdetect,NR_Intra, Tmeasure,NR_Intra and Tevaluate,NR_Intra.

In summary, in the method for measurement indication provided in the embodiments of the present disclosure, the UE may acquire the RRM requirement enhancement indication information sent by the network side device, and the RRM requirement enhancement indication information is configured to indicate the enhanced RRM requirement required to be met in a process that the UE performs the RRM measurement. From this, it may be seen that in the embodiments of the present disclosure, the UE performs the RRM measurement using the enhanced RRM requirement according to the RRM requirement enhancement indication information, such that a duration required for the UE to complete one RRM measurement process is relatively short, and thus a duration required for cell reselection/switching process of the UE is relatively short, thereby ensuring the mobility management performance of the UE.

FIG. 1b is a flowchart of another method for measurement indication provided in embodiments of the present disclosure, performed by the UE. As shown in FIG. 1b, the method for measurement indication may include a following step 101b:

in step 101b: when the UE is in a non-connected state, RRM requirement enhancement indication information sent by the network side device is acquired through a SIB message, the RRM requirement enhancement indication information is configured to indicate an enhanced RRM requirement required to be met in a process that the UE performs RRM measurement.

The detailed introduction to the RRM requirement enhancement indication information may refer to the relevant introduction in the above embodiments, which will not be repeated herein.

In summary, in the method for measurement indication provided in the embodiments of the present disclosure, the UE may acquire the RRM requirement enhancement indication information sent by the network side device, and the RRM requirement enhancement indication information is configured to indicate the enhanced RRM requirement required to be met in a process that the UE performs the RRM measurement. From this, it may be seen that in the embodiments of the present disclosure, the UE performs the RRM measurement using the enhanced RRM requirement according to the RRM requirement enhancement indication information, such that a duration required for the UE to complete one RRM measurement process is relatively short, and thus a duration required for cell reselection/switching process of the UE is relatively short, thereby ensuring the mobility management performance of the UE.

FIG. 1c is a flowchart of another method for measurement indication provided in embodiments of the present disclosure, performed by the UE. As shown in FIG. 1c, the method for measurement indication may include a following step 101c:
in step 101c: when the UE is in a connected state, RRM requirement enhancement indication information sent by a network side device is acquired through an RRC signaling, and the RRM requirement enhancement indication information is configured to indicate an enhanced RRM requirement required to be met in a process that the UE performs RRM measurement.

The detailed introduction to the RRM requirement enhancement indication information may refer to the relevant introduction in the above embodiments, which will not be repeated herein.

In summary, in the method for measurement indication provided in the embodiments of the present disclosure, the UE may acquire the RRM requirement enhancement indication information sent by the network side device, and the RRM requirement enhancement indication information is configured to indicate the enhanced RRM requirement required to be met in a process that the UE performs the RRM measurement. From this, it may be seen that in the embodiments of the present disclosure, the UE performs the RRM measurement using the enhanced RRM requirement according to the RRM requirement enhancement indication information, such that a duration required for the UE to complete one RRM measurement process is relatively short, and thus a duration required for cell reselection/switching process of the UE is relatively short, thereby ensuring the mobility management performance of the UE.

FIG. 2 is a flowchart of another method for measurement indication provided in embodiments of the present disclosure, performed by the UE. As shown in FIG. 2, the method for measurement indication may include the following steps 201-202:
in step 201: capability information is sent to the network side device.

In an embodiment of the present disclosure, the capability information may be configured to indicate whether the UE supports enhanced RRM requirement. That is, the capability information is configured to indicate whether the UE supports at least one of the following requirements: an enhanced mobility requirement for the UE in a non-connected state; an enhanced mobility requirement for the UE in a connected state; an enhanced cell activation latency requirement; an enhanced cell deactivation latency requirement; or an enhanced beam management requirement.

In an embodiment of the present disclosure, the method of sending the capability information to the network side device may include at least one of the following:
sending the capability information to the network side device through IE MeasAndMobParameters (information element measurement and mobility parameter capability indication information); or
sending the capability information to the network side device through IE MeasAndMobParametersMRDC (measurement and mobility parameter capability indication information in an information element scenario).

In step 202: when the capability information indicates that the UE supports the enhanced RRM requirement, the RRM requirement enhancement indication information sent by the network side device is acquired.

In an embodiment of the present disclosure, after receiving the capability information sent by the UE, the network side device needs to determine whether the UE supports the enhanced RRM requirement based on capability information of the UE.

Specifically, in an embodiment of the present disclosure, the capability information may be an indication value, and different indication values indicate different meanings. When the capability information is a first indication value (such as, 1), it indicates that the UE supports the enhanced RRM requirement; when the capability information is a second indication value (such as, 2), it indicates that the UE does not support the enhanced RRM requirement.

Furthermore, in an embodiment of the present disclosure, when the capability information indicates that the UE supports the enhanced RRM requirement, the network side device sends the RRM requirement enhancement indication information to the UE such that the UE may perform the RRM measurement using the enhanced RRM requirement according to the RRM requirement enhancement indication information.

The detail introduction about acquiring the RRM requirement enhancement indication information sent by the network side device may refer to the relevant introduction in the above embodiments, which will not be repeated herein.

In summary, in the method for measurement indication provided in the embodiments of the present disclosure, the UE may acquire the RRM requirement enhancement indication information sent by the network side device, and the RRM requirement enhancement indication information is configured to indicate the enhanced RRM requirement required to be met in a process that the UE performs the RRM measurement. From this, it may be seen that in the embodiments of the present disclosure, the UE performs the RRM measurement using the enhanced RRM requirement according to the RRM requirement enhancement indication information, such that a duration required for the UE to complete one RRM measurement process is relatively short, and thus a duration required for cell reselection/switching process of the UE is relatively short, thereby ensuring the mobility management performance of the UE.

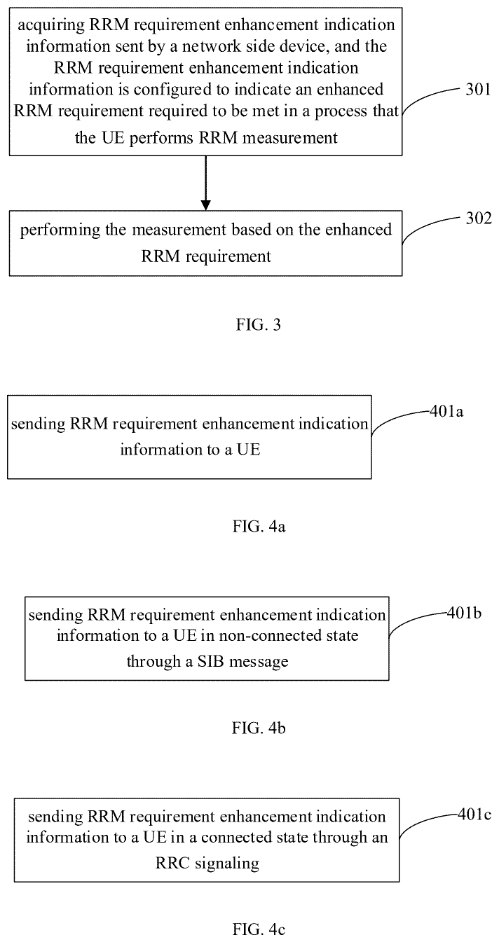

FIG. 3 is a flowchart of another method for measurement indication provided in embodiments of the present disclosure, performed by the UE. As shown in FIG. 3, the method for measurement indication may include the following steps 301-302:

In step 301: RRM requirement enhancement indication information sent by a network side device is acquired, and the RRM requirement enhancement indication information is configured to indicate an enhanced RRM requirement required to be met in a process that the UE performs RRM measurement.

The detailed introduction to step 301 may refer to the description of the above embodiments, which will not be repeated herein.
in step 302: the measurement is performed based on the enhanced RRM requirement.

In an embodiment of the present disclosure, when the UE performs the measurement based on the enhanced RRM requirement, the main approach is to use the enhanced RRM requirement corresponding to a current measurement process.

Specifically, in an embodiment of the present disclosure, the enhanced RRM requirement may include at least one of the following:
an enhanced mobility requirement for the UE in a non-connected state;
an enhanced mobility requirement for the UE in a connected state;
an enhanced cell activation latency requirement;
an enhanced cell deactivation latency requirement; or
an enhanced beam management requirement.

Based on this, in an embodiment of the present disclosure, when the UE in the non-connected state needs to perform the RRM measurement on a neighbor cell based on the mobility requirement of the UE in the non-connected state, the UE in the non-connected state may complete the RRM measurement on the neighbor cell according to the enhanced mobility requirement of the UE in the non-connected state.

In another embodiment of the present disclosure, when the UE in a connected state needs to perform the RRM measurement on a neighbor cell based on the mobility requirement of the UE in the connected state, the UE in the connected state may complete the RRM measurement on the neighbor cell according to the enhanced mobility requirement of the UE in the connected state.

In another embodiment of the present disclosure, when the UE needs to activate a cell after receiving an activation signaling sent by the network device, the UE may complete the cell activation based on the enhanced cell activation latency requirement.

In another embodiment of the present disclosure, when the UE needs to deactivate a cell after receiving a deactivation signaling sent by the network device, the UE may complete the cell deactivation based on the enhanced cell deactivation latency requirement.

In another embodiment of the present disclosure, when the UE needs to perform beam measurement and beam evaluation based on a beam management requirement, the UE may complete the beam measurement and the beam evaluation based on the enhanced beam management requirement.

Furthermore, it should be noted that in the embodiments of the present disclosure, the prerequisite for the UE to perform the measurement based on the above enhanced RRM requirement should be that the UE supports the enhanced RRM requirement. For example, assuming that the UE needs to complete the measurement based on the enhanced mobility requirement of the UE in the non-connected state, the UE should support the enhanced mobility requirement of the UE in the non-connected state.

In summary, in the method for measurement indication provided in the embodiments of the present disclosure, the UE may acquire the RRM requirement enhancement indication information sent by the network side device, and the RRM requirement enhancement indication information is configured to indicate the enhanced RRM requirement required to be met in a process that the UE performs the RRM measurement. From this, it may be seen that in the embodiments of the present disclosure, the UE performs the RRM measurement using the enhanced RRM requirement according to the RRM requirement enhancement indication information, such that a duration required for the UE to complete one RRM measurement process is relatively short, and thus a duration required for cell reselection/switching process of the UE is relatively short, thereby ensuring the mobility management performance of the UE.

FIG. 4a is a flowchart of another method for measurement indication provided in embodiments of the present disclosure, performed by a network side device. As shown in FIG. 4a, the method for measurement indication may include a following step 401a:
in step 401a: RRM requirement enhancement indication information is sent to a UE.

In an embodiment of the present disclosure, the RRM requirement enhancement indication information may be configured to indicate an enhanced RRM requirement required to be met in a process that the UE performs RRM measurement.

In an embodiment of the present disclosure, the enhanced RRM requirement may include at least one of the following:
an enhanced mobility requirement for the UE in a non-connected state;
an enhanced mobility requirement for the UE in a connected state;
an enhanced cell activation latency requirement;
an enhanced cell deactivation latency requirement; or
an enhanced beam management requirement.
   Furthermore, in the embodiments of the present disclosure, the method of sending the RRM requirement enhancement indication information to the UE may include: sending the RRM requirement enhancement indication information to the UE in a non-connected state through a SIB message.

In another embodiment of the present disclosure, the method of sending the RRM requirement enhancement indication information to the UE may include: sending the RRM requirement enhancement indication information to the UE in a connected state through an RRC signaling.

In addition, in an embodiment of the present disclosure, after acquiring the RRM requirement enhancement indication information sent by the network side device, the UE may perform the RRM measurement using the enhanced RRM requirement based on the RRM requirement enhancement indication information.

Other detailed introduction to step 401a may refer to the description of the above embodiments, which will not be repeated herein.

In summary, in the method for measurement indication provided in embodiments of the present disclosure, the network side device may send the RRM requirement enhancement indication information to the UE, and the RRM requirement enhancement indication information is configured to indicate the enhanced RRM requirement required to be met in a process that the UE performs the RRM measurement. From this, it may be seen that in the embodiments of the present disclosure, the UE performs the RRM measurement using the enhanced RRM requirement according to the RRM requirement enhancement indication information, such that a duration required for the UE to complete one RRM measurement process is relatively short, and thus a duration required for cell reselection/switching process of the UE is relatively short, thereby ensuring the mobility management performance of the UE.

FIG. 4b is a flowchart of another method for measurement indication provided in embodiments of the present disclosure, performed by a network side device. As shown in FIG. 4b, the method for measurement indication may include a following step 401b:

In step 401b: RRM requirement enhancement indication information is sent to a UE in non-connected state through a SIB message.

Other detailed introduction to step 401b may refer to the description of the above embodiments, which will not be repeated herein.

In summary, in the method for measurement indication provided in embodiments of the present disclosure, the network side device may send the RRM requirement enhancement indication information to the UE, and the RRM requirement enhancement indication information is configured to indicate the enhanced RRM requirement required to be met in a process that the UE performs the RRM measurement. From this, it may be seen that in the embodiments of the present disclosure, the UE performs the RRM measurement using the enhanced RRM requirement according to the RRM requirement enhancement indication information, such that a duration required for the UE to complete one RRM measurement process is relatively short, and thus a duration required for cell reselection/switching process of the UE is relatively short, thereby ensuring the mobility management performance of the UE.

FIG. 4c is a flowchart of another method for measurement indication provided in embodiments of the present disclosure, performed by a network side device. As shown in FIG. 4c, the method for measurement indication may include a following step 401c:
in step 401c: RRM requirement enhancement indication information is sent to a UE in a connected state through an RRC signaling.

Other detailed introduction to step 401c may refer to the description of the above embodiments, which will not be repeated herein.

In summary, in the method for measurement indication provided in embodiments of the present disclosure, the network side device may send the RRM requirement enhancement indication information to the UE, and the RRM requirement enhancement indication information is configured to indicate the enhanced RRM requirement required to be met in a process that the UE performs the RRM measurement. From this, it may be seen that in the embodiments of the present disclosure, the UE performs the RRM measurement using the enhanced RRM requirement according to the RRM requirement enhancement indication information, such that a duration required for the UE to complete one RRM measurement process is relatively short, and thus a duration required for cell reselection/switching process of the UE is relatively short, thereby ensuring the mobility management performance of the UE.

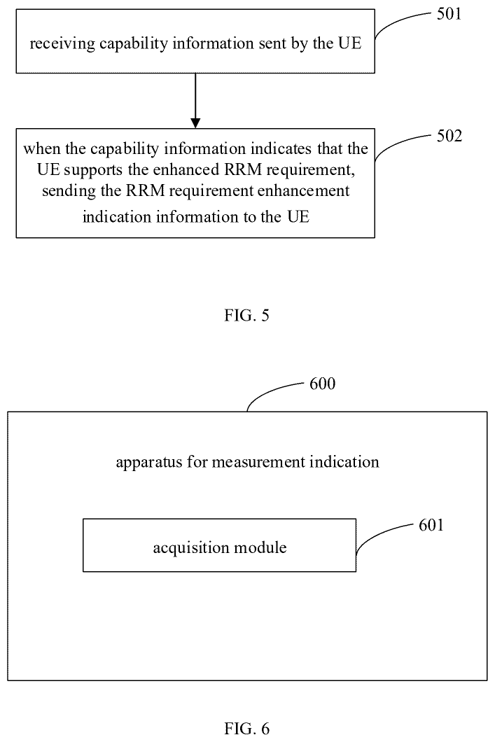

FIG. 5 is a flowchart of another method for measurement indication provided in embodiments of the present disclosure, performed by a network side device. As shown in FIG. 5, the method for measurement indication may include the following steps 501-502: in step 501: capability information sent by the UE is received.

In an embodiment of the present disclosure, the capability information is configured to indicate whether the UE supports the enhanced RRM requirement.

In an embodiment of the present disclosure, the method of receiving the capability information sent by UE may include at least one of the following:
receiving the capability information sent by the UE through IE MeasAndMobParameters; or
receiving the capability information sent by the UE through IE Meas AndMobParametersMRDC.

In step 502: when the capability information indicates that the UE supports the enhanced RRM requirement, the RRM requirement enhancement indication information is sent to the UE.

Other detailed introduction to steps 501-502 may refer to the description of the above embodiments, which will not be repeated herein.

In summary, in the method for measurement indication provided in embodiments of the present disclosure, the network side device may send the RRM requirement enhancement indication information to the UE, and the RRM requirement enhancement indication information is configured to indicate the enhanced RRM requirement required to be met in a process that the UE performs the RRM measurement. From this, it may be seen that in the embodiments of the present disclosure, the UE performs the RRM measurement using the enhanced RRM requirement according to the RRM requirement enhancement indication information, such that a duration required for the UE to complete one RRM measurement process is relatively short, and thus a duration required for cell reselection/switching process of the UE is relatively short, thereby ensuring the mobility management performance of the UE.

FIG. 6 shows a structural diagram of an apparatus for measurement indication provided in an embodiment of the present disclosure. As shown in FIG. 6, the apparatus 600 may include:
an acquisition module 601, configured to acquire RRM requirement enhancement indication information sent by a network side device, and the RRM requirement enhancement indication information is configured to indicate an enhanced RRM requirement required to be met in a process that a UE performs RRM measurement.

In summary, in the apparatus for measurement indication provided in embodiments of the present disclosure, the UE may acquire the RRM requirement enhancement indication information sent by the network side device, and the RRM requirement enhancement indication information is configured to indicate the enhanced RRM requirement required to be met in a process that the UE performs the RRM measurement. From this, it may be seen that in the embodiments of the present disclosure, the UE performs the RRM measurement using the enhanced RRM requirement according to the RRM requirement enhancement indication information, such that a duration required for the UE to complete one RRM measurement process is relatively short, and thus a duration required for cell reselection/switching process of the UE is relatively short, thereby ensuring the mobility management performance of the UE.

In an embodiment of the present disclosure, the enhanced RRM requirement is stricter than an unenhanced RRM requirement.

Furthermore, in another embodiment of the present disclosure, the above apparatus is further configured to:
send capability information to the network side device, where the capability information is configured to indicate whether the UE supports the enhanced RRM requirement.
   Furthermore, in another embodiment of the present disclosure, the aforementioned acquisition module 601 is further configured to:
when the capability information indicates that the UE supports the enhanced RRM requirement, acquire the RRM requirement enhancement indication information sent by the network side device.

Furthermore, in another embodiment of the present disclosure, the enhanced RRM requirement includes at least one of the following:
an enhanced mobility requirement for the UE in a non-connected state;
an enhanced mobility requirement for the UE in a connected state;
an enhanced cell activation latency requirement;
an enhanced cell deactivation latency requirement; or
an enhanced beam management requirement.

Furthermore, in another embodiment of the present disclosure, the aforementioned acquisition module 601 is further configured to:
when the UE is in a non-connected state, acquire the RRM requirement enhancement indication information sent by the network side device through a SIB message.

Furthermore, in another embodiment of the present disclosure, the aforementioned acquisition module 601 is further configured to:
when the UE is in a connected state, acquire the RRM requirement enhancement indication information sent by the network side device through an RRC signaling.

Furthermore, in another embodiment of the present disclosure, the above apparatus is further configured to:
send the capability information to the network side device through IE MeasAndMobParameters;
send the capability information to the network side device through IE Meas AndMobParametersMRDC.

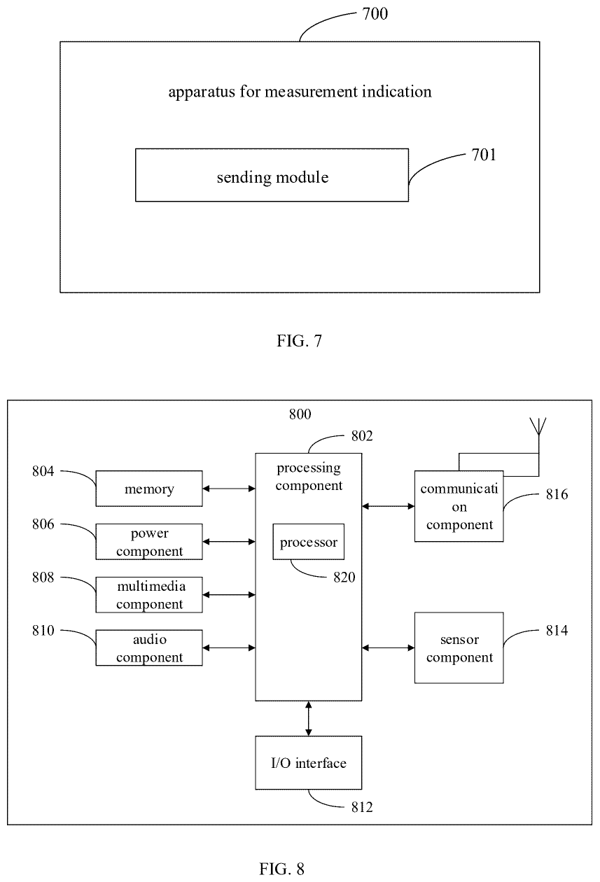

FIG. 7 shows a structural diagram of an apparatus for measurement indication provided in an embodiment of the present disclosure. As shown in FIG. 7, the apparatus 700 may include:
a sending module 701, configured to send RRM requirement enhancement indication information to a UE, where the RRM requirement enhancement indication information is configured to indicate an enhanced RRM requirement required to be met in a process that the UE performs RRM measurement.

In summary, in the apparatus for measurement indication provided in embodiments of the present disclosure, the network side device may send the RRM requirement enhancement indication information to the UE, and the RRM requirement enhancement indication information is configured to indicate the enhanced RRM requirement required to be met in a process that the UE performs the RRM measurement. From this, it may be seen that in the embodiments of the present disclosure, the UE performs the RRM measurement using the enhanced RRM requirement according to the RRM requirement enhancement indication information, such that a duration required for the UE to complete one RRM measurement process is relatively short, and thus a duration required for cell reselection/switching process of the UE is relatively short, thereby ensuring the mobility management performance of the UE.

In an embodiment of the present disclosure, the enhanced RRM requirement is stricter than an unenhanced RRM requirement.

Furthermore, in another embodiment of the present disclosure, the above apparatus is further configured to:
receive capability information sent by the UE, and the capability information is configured to indicate whether the UE supports the enhanced RRM requirement.

Furthermore, in another embodiment of the present disclosure, the above-mentioned sending module 701 is further configured to:
when the capability information indicates that the UE supports the enhanced RRM requirement, send the RRM requirement enhancement indication information to the UE.

Furthermore, in another embodiment of the present disclosure, the enhanced RRM requirement includes at least one of the following:
an enhanced mobility requirement for the UE in a non-connected state;
an enhanced mobility requirement for the UE in a connected state;
an enhanced cell activation latency requirement;
an enhanced cell deactivation latency requirement; or
an enhanced beam management requirement.

Furthermore, in another embodiment of the present disclosure, the above-mentioned sending module 701 is further configured to:
send the RRM requirement enhancement indication information to the UE in a non-connected state through a SIB message.

Furthermore, in another embodiment of the present disclosure, the above-mentioned sending module 701 is further configured to:
send the RRM requirement enhancement indication information to the UE in a connected state through an RRC signaling.

Furthermore, in another embodiment of the present disclosure, the apparatus is further configured to:
receive the capability information sent by the UE through IE MeasAndMobParameters; or receive the capability information sent by the UE through IE Meas AndMobParametersMRDC.

FIG. 8 is a schematic structural diagram of the UE 800 provided by an embodiment of the present disclosure. For example, the UE 800 may be a mobile phone, a computer, a digital broadcast device, a messaging device, a game console, a tablet device, a medical device, a fitness device, a personal digital assistant, etc.

Referring to FIG. 8, the UE 800 may include at least one of the following components: a processing component 802, a memory 804, a power component 806, a multimedia component 808, an audio component 810, an input/output (I/O) interface 812, a sensor component 813, and a communication component 816.

The processing component 802 typically controls the overall operations of the UE 800, such as the operations associated with display, telephone calls, data communications, camera operations, and recording operations. The processing component 802 may include one or more processors 820 to execute instructions to perform all or part of the steps in the above described methods. Moreover, the processing component 802 may include at least one module to facilitate the interaction between the processing component 802 and other components. For example, the processing component 802 may include a multimedia module to facilitate the interaction between the multimedia component 808 and the processing component 802.

The memory 804 is configured to store various types of data to support the operation of the UE 800. Examples of such data include instructions for any application or method operated on the, such as the contact data, the phone book data, messages, pictures, videos, and the like. The memory 804 may be implemented by any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the UE 800. The power component 806 may include a power management system, at least one power source, and other components associated with the generation, management, and distribution of power for the UE 800.

The multimedia component 808 includes a screen providing an output interface between the UE 800 and the user. In some embodiments, the screen may include a liquid crystal display (LCD) and a touch panel (TP). If the screen includes the touch panel, the screen may be implemented as a touch screen to receive input signals from the user. The touch panel includes at least one touch sensor to sense touches, swipes, and gestures on the touch panel. The touch sensors may not only sense a boundary of a touch or swipe action, but also detect the wake-up time and pressure associated with the touch or swipe action. In some embodiments, the multimedia component 808 includes a front camera and/or a rear camera. When the UE 800 is in an operation mode, such as a photographing mode or a video mode, the front camera and/or the rear camera may receive external multimedia data. Each of the front camera and the rear camera may be a fixed optical lens system or have focus and optical zoom capability.

The audio component 810 is configured to output and/or input an audio signal. For example, the audio component 810 includes a microphone (MIC) configured to receive an external audio signal when the UE 800 is in an operation mode, such as a call mode, a recording mode, and a voice recognition mode. The received audio signal may be further stored in the memory 804 or sent via the communication component 816. In some embodiments, the audio component 810 also includes a speaker for outputting the audio signal.

The I/O interface 812 provides an interface between the processing component 802 and peripheral interface modules, such as keyboards, a click wheels, buttons, and the like. These buttons may include, but not limited to, a home button, a volume button, a starting button, and a locking button.

The sensor component 813 includes at least one sensor for providing state assessments of various aspects of the UE 800. For example, the sensor component 813 may detect an open/closed state of the UE 800, relative positioning of components, such as the display and the keypad of the UE 800. The sensor component 813 may also detect a change in position of one component of the UE 800 or the UE 800, the presence or absence of user contact with the UE 800, an orientation, or an acceleration/deceleration of the UE 800, and a change in temperature of the UE 800. The sensor component 813 may also include a proximity sensor configured to detect the presence of nearby objects without any physical contact. The sensor component 813 may also include a light sensor, such as a CMOS or CCD image sensor, configured to use in imaging applications. In some embodiments, the sensor component 813 may also include an accelerometer sensor, a gyroscope sensor, a magnetic sensor, a pressure sensor, or a temperature sensor.

The communication component 816 is configured to facilitate wired or wireless communication between the UE 800 and other devices. The UE 800 may access a wireless network based on a communication standard, such as WiFi, 2G, 3G, or a combination thereof. In an example embodiment, the communication component 816 receives broadcast signals or broadcast associated information from an external broadcast management system via a broadcast channel. In an example embodiment, the communication component 816 also includes a near field communication (NFC) module to facilitate short-range communications. For example, the NFC module may be implemented based on radio frequency identification (RFID) technology, infrared data association (IrDA) technology, ultra-wideband (UWB) technology, Bluetooth (BT) technology and other technologies.

In an example embodiment, the UE 800 may be implemented with at least one application specific integrated circuit (ASIC), digital signal processor (DSP), digital signal processing device (DSPD), programmable logic device (PLD), field programmable Gate array (FPGA), controller, microcontroller, microprocessor or other electronic components, to perform the above methods.

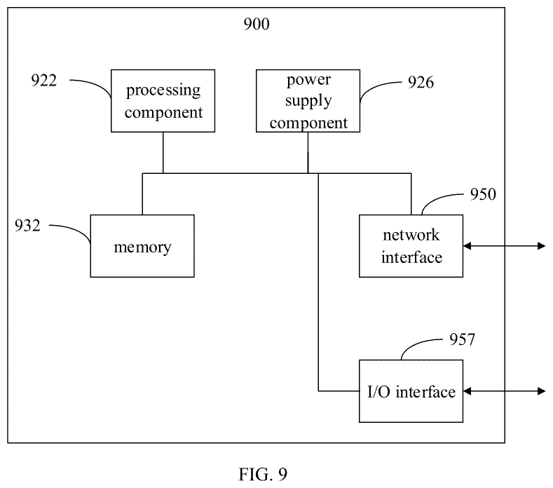

FIG. 9 is a block diagram of a network side device 900 provided in an embodiment of the present application. For example, the network side device 900 may be provided as a network side device. Referring to FIG. 9, the network side device 900 may include a processing component 911, which further includes at least one processor, and memory resources represented by a memory 932, for storing instructions, such as application programs, that may be executed by processing component 922. An application stored in memory 932 may include one or more modules, each of which corresponds to a set of instructions. In addition, the processing component 917 is configured to execute instructions to execute any of the above methods applied to the network side device, for example, the method shown in FIG. 1.

The network side device 900 may also include a power supply component 926 configured to perform power management of the network side device 900, a wired or wireless network interface 950 configured to connect the network side device 900 to the network, and an input/output (I/O) interface 957. The network side device 900 may operate based on an operating system stored in the memory 932, such as Windows Server™, Mac OS X™, Unix™, Linux™, FreeBSD™ or the like.

In the above embodiments provided by the present disclosure, the methods provided by the embodiments of the present disclosure are introduced from the perspectives of the network side device, UE, and RIS array. In order to implement the functions of the methods provided by the above embodiments of the present disclosure, the network side device and the UE may include a hardware structure and a software module, and the above functions are implemented in the form of a hardware structure, a software module, or a hardware structure plus a software module. One of the above functions may be executed in the form of a hardware structure, a software module, or a hardware structure plus a software module.

In the above embodiments provided by the present disclosure, the methods provided by the embodiments of the present disclosure are introduced from the perspectives of the network side device, UE, and RIS array. In order to implement the functions of the methods provided by the above embodiments of the present disclosure, the network side device and the UE may include a hardware structure and a software module, and the above functions are implemented in the form of a hardware structure, a software module, or a hardware structure plus a software module. One of the above functions may be executed in the form of a hardware structure, a software module, or a hardware structure plus a software module.

A communication apparatus is provided in the embodiments of the present disclosure. The communication apparatus may include a transceiver module and a processing module. The transceiver module may include a sending module and/or a receiving module, the sending module is used to implement the sending function, the receiving module is used to implement the receiving function, and the transceiver module may implement the sending function and/or the receiving function.

The communication apparatus may be a terminal device (such as the terminal device in the above method embodiment), or an apparatus in the terminal device, or an apparatus that may be used in combination with the terminal device. Alternatively, the communication apparatus may be a network device, or an apparatus in the network device, or an apparatus that may be used in combination with the network device.

Another communication apparatus is provided in the embodiment of the present disclosure. The communication apparatus may be a network device, or a terminal device (such as the terminal device in the above method embodiments), or a chip, a chip system, or a processor that supports the network device to implement the above methods, or a chip, a chip system, or a processor that supports the terminal device to implement the above methods. The apparatus may be used to implement the methods described in the above method embodiments, and the details may refer to the description in the above method embodiments.

The communication apparatus may include one or more processors. The processor may be a general-purpose processor or a dedicated processor, or the like. For example, the processor may be a baseband processor or a central processor. The baseband processor may be used to process the communication protocol and the communication data, and the central processor may be used to control the communication apparatus (such as the network side device, the baseband chip, the terminal device, the terminal device chip, the DU or the CU, etc.), execute the computer program, and process the data of the computer program.

In some embodiments, the communication apparatus may also include one or more memories, on which a computer program may be stored, and the processor executes the computer program, so that the communication apparatus executes the methods described in the above method embodiments. In some embodiments, data may also be stored in the memory. The communication apparatus and the memory may be provided separately or integrated together.

In some embodiments, the communication apparatus may also include a transceiver and an antenna. The transceiver may be referred to as a transceiver unit, a transceiver machine, or a transceiver circuit, etc., for realizing the transceiver function. The transceiver may include a receiver and a transmitter, the receiver may be referred to as a receiver machine or a receiving circuit, etc., for realizing the receiving function; the transmitter may be referred to as a transmitter machine or a transmitting circuit, etc., for realizing the transmitting function.

In some embodiments, the communication apparatus may also include one or more interface circuits. The interface circuit is used to receive the code instruction and transmit it to the processor. The processor runs the code instruction to enable the communication apparatus to execute the methods described in the above method embodiments.

The communication apparatus is a terminal device (such as the terminal device in the above method embodiments), the processor is used to execute the methods shown in any one of FIGS. 1 to 3.

The communication apparatus is a network device: a transceiver is used to execute the methods shown in any one of FIGS. 4 to 5.

In one implementation, the processor may include a transceiver for implementing receiving and transmitting functions. For example, the transceiver may be a transceiver circuit, or an interface, or an interface circuit. The transceiver circuit, interface or interface circuit for implementing the receiving and transmitting functions may be separate or integrated. The above transceiver circuit, interface or interface circuit may be used for reading and writing code/data, or the above transceiver circuit, interface or interface circuit may be used for transmitting or delivering signals.

In one implementation, the processor may store a computer program, and the computer program runs on the processor, so that the communication apparatus may perform the methods described in the above method embodiments. The computer program may be solidified in the processor, in which case the processor may be implemented by hardware.

In one implementation, the communication apparatus may include a circuit, the circuit may implement the functions of transmitting or receiving or communicating in the preceding method embodiments. The processors and transceivers described in this disclosure may be implemented on integrated circuits (ICs), analog ICs, radio frequency integrated circuits RFICs, mixed signal ICs, application specific integrated circuits (ASICs), Printed circuit boards (PCBs), electronic devices, etc. The processor and transceiver may also be manufactured by various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (Gas), etc.

The communication apparatus described in the above embodiments may be a network device or a terminal device (for example, the terminal device in the above method embodiments), but the scope of the communication apparatus described in the present disclosure is not limited thereto, and the structure of the communication apparatus may not be limited. The communication apparatus may be a stand-alone device or may be part of a larger device. For example the described communication apparatus may be:
(1) a stand-alone integrated circuit IC, or chip, or, chip system or subsystem;
(2) a collection having one or more ICs, in some embodiments, the collection of ICs may also include storage components for storing data, computer programs;
(3) an ASIC, such as a Modem;
(4) modules that may be embedded within other devices;
(5) receivers, terminal devices, smart terminal devices, cellular phones, wireless devices, handhelds, mobile units, in-vehicle devices, network devices, cloud devices, artificial intelligence devices, and the like;
(6) others, etc.

For the case where the communication apparatus may be a chip or a chip system, the chip includes a processor and an interface. The number of processors may be one or more, and the number of interfaces may be more than one.

In some embodiments, the chip further includes a memory, the memory is used for storing necessary computer programs and data.

Those skilled in the art may also appreciate that various illustrative logical blocks and steps listed in the embodiments of the present disclosure may be implemented by electronic hardware, computer software, or a combination of both. Whether such function is implemented by hardware or software depends on the particular application and the design requirements of the overall system. A person skilled in the art may use a variety of methods to implement the described function for each particular application, but such implementations should not be construed as being going beyond the scope of protection of embodiments of the present disclosure.

The embodiments of the present disclosure also provide a system for determining the duration of a side link, the system including a communication apparatus as a terminal device (such as the first terminal device in the embodiment of the method) and a communication apparatus as a network device in the above embodiment, or the system includes a communication apparatus as a terminal device (such as the first terminal device in the embodiment of the method) and a communication apparatus as a network device in the above embodiment.

The present disclosure also provides a non-transitory readable storage medium having stored thereon instructions which, when executed by a computer, realize the functions of any of the foregoing method embodiments.

The present disclosure also provides a computer program product which realizes the function of any of the above-described method embodiments when executed by a computer.

In the above embodiments, this may be realized in whole or in part by software, hardware, firmware, or any combination thereof. When implemented using software, it may be implemented in whole or in part in the form of a computer program product. The computer program product includes one or more computer programs. When loading and executing the computer program on a computer produces, a process or function in accordance with embodiments of the present disclosure is generated in whole or in part. The computer may be a general purpose computer, a specialized computer, a computer network, or other programmable devices. The computer program may be stored in a computer-readable storage medium or transmitted from one computer-readable storage medium to another computer-readable storage medium. For example, the computer program may be transmitted from a web site, computer, server, or data center via a wired (e.g., coaxial cable, fiber optic, digital subscriber line (DSL)) or wireless (e.g., infrared, wireless, microwave, etc.) to another website site, computer, server, or data center. The computer-readable storage medium may be any available medium that a computer may access or a data storage device such as a server, a data center and the like that contains one or more available media integration. The usable medium may be a magnetic medium (e.g., floppy disk, hard disk, magnetic tape), an optical medium (e.g., high-density digital video disc (DVD)), or a semiconductor medium (e.g., solid state disk (SSD)) and the like.

A person of ordinary skill in the art may understand that the first, second, and other various numerical numbers involved in the present disclosure are only for the convenience of description, and are not used to limit the scope of the embodiments of this disclosure, but also indicate the order.

The at least one in the present disclosure may also be described as one or more, and the plurality may be two, three, four, or more, which is not limited by the present disclosure. In embodiments of the present disclosure, for a technical feature, a technical feature is described by “first”, “second”, “third”, “A”, “B”, “C”, and “D”, etc., to distinguish the technical features in the kind of technical features, technical features described with the “first”, “second”, “third”, “A”, “B”, “C”, and “D” are not in any order of precedence or magnitude.

Other embodiments of the present disclosure will easily occur to those skilled in the art after considering the specification and practicing the disclosure disclosed herein. The present disclosure is intended to cover any variation, use or adaptation of the present disclosure, which follows the general principles of the present disclosure and includes common sense or common technical means in the technical field not disclosed in this disclosure. The specification and embodiments are to be regarded as example only, with the true scope and spirit of the disclosure being indicated by the attached claims.

It should be understood that the present disclosure is not limited to the precise structure described above and shown in the drawings, and various modifications and changes may be made without departing from its scope. The scope of the present disclosure is limited only by the appended claims.

1. A method for measurement indication, performed by a user device (UE), comprising:
acquiring Radio Resource Management (RRM) requirement enhancement indication information sent by a network side device, wherein the RRM requirement enhancement indication information is configured to indicate an enhanced RRM requirement required to be met in a process that the UE performs RRM measurement.

2. The method according to claim 1, wherein the enhanced RRM requirement is stricter than an unenhanced RRM requirement.

3. The method according to claim 1, further comprising:
sending capability information to the network side device, wherein the capability information is configured to indicate whether the UE supports the enhanced RRM requirement.

4. The method according to claim 3, wherein acquiring the RRM requirement enhancement indication information sent by the network side device comprises:
acquiring, in response to that the capability information indicates that the UE supports the enhanced RRM requirement, the RRM requirement enhancement indication information sent by the network side device.

5. The method according to claim 1, wherein the enhanced RRM requirement comprises at least one of following:
an enhanced mobility requirement for the UE in a non-connected state;
an enhanced mobility requirement for the UE in a connected state;
an enhanced cell activation latency requirement;
an enhanced cell deactivation latency requirement; or
an enhanced beam management requirement.

6. The method according to claim 1, wherein acquiring the RRM requirement enhancement indication information sent by the network side device comprises:
acquiring, in response to that the UE is in a non-connected state, the RRM requirement enhancement indication information sent by the network side device through a System Information Block (SIB) message.

7. The method according to claim 1, wherein acquiring the RRM requirement enhancement indication information sent by the network side device comprises:
acquiring, in response to that the UE is in a connected state, the RRM requirement enhancement indication information sent by the network side device through a Radio Resource Control (RRC) signaling.

8. The method according to claim 3, wherein sending the capability information to the network side device comprises at least one of following:
sending the capability information to the network side device through IE MeasAndMobParameters; or
sending the capability information to the network side device through IE MeasAndMobParametersMRDC.

9. A method for measurement indication, performed by a network side device, comprising:
sending Radio Resource Management (RRM) requirement enhancement indication information to a UE, wherein the RRM requirement enhancement indication information is configured to indicate an enhanced RRM requirement required to be met in a process that the UE performs RRM measurement.

10. The method according to claim 9, wherein the enhanced RRM requirement is stricter than an unenhanced RRM requirement.

11. The method according to claim 9, further comprising:
receiving capability information sent by the UE, wherein the capability information is configured to indicate whether the UE supports the enhanced RRM requirement.

12. The method according to claim 11, wherein sending the RRM requirement enhancement indication information to the UE comprises:
sending, in response to that the capability information indicates that the UE supports the enhanced RRM requirement, the RRM requirement enhancement indication information to the UE.

13. The method according to claim 9, wherein the enhanced RRM requirement comprises at least one of following:
an enhanced mobility requirement for the UE in a non-connected state;
an enhanced mobility requirement for the UE in a connected state;
an enhanced cell activation latency requirement;
an enhanced cell deactivation latency requirement; or
an enhanced beam management requirement.

14. The method according to claim 9, wherein sending the RRM requirement enhancement indication information to the UE comprises:
sending the RRM requirement enhancement indication information to the UE in a non-connected state through a System Information Block (SIB) message.

15. The method according to claim 9, wherein sending the RRM requirement enhancement indication information to the UE comprises:
sending the RRM requirement enhancement indication information to the UE in a connected state through a Radio Resource Control (RRC) signaling.

16. The method according to claim 11, wherein receiving the capability information sent by the UE comprises at least one of following:
receiving the capability information sent by the UE through IE MeasAndMobParameters; or
receiving the capability information sent by the UE through IE MeasAndMobParametersMRDC.

17.-18. (canceled)

19. A communication apparatus, comprising a processor and a memory, wherein
the memory is configured to store a computer program; and
the processor is configured to acquire Radio Resource Management (RRM) requirement enhancement indication information sent by a network side device, wherein the RRM requirement enhancement indication information is configured to indicate an enhanced RRM requirement required to be met in a process that a UE performs RRM measurement.

20. A communication apparatus, comprising a processor and a memory, wherein
the memory is configured to store a computer program; and
the processor is configured to execute the computer program stored in the memory to implement the method according to claim 9.

21.-24. (canceled)

25. The communication apparatus according to claim 19, wherein the enhanced RRM requirement is stricter than an unenhanced RRM requirement.

26. The communication apparatus according to claim 19, wherein the processor is further configured to:
send capability information to the network side device, wherein the capability information is configured to indicate whether the UE supports the enhanced RRM requirement.
